(19) United States
(12) Patent Application Publication
(10) Pub. No.: US 2014/0324565 A1
(43) Pub. Date: Oct. 30, 2014

(54) MOBILE ECOMMERCE PLATFORM

(71) Applicant: Nitesh Ratnakar, Wheeling, WV (US)

(72) Inventor: Nitesh Ratnakar, Wheeling, WV (US)

(21) Appl. No.: 14/217,248

(22) Filed: Mar. 17, 2014

Related U.S. Application Data
(60) Provisional application No. 61/791,572, filed on Mar. 15, 2013.

(51) Int. Cl. G06Q 30/02

(52) U.S. Cl. CPC G06Q 30/0236; G06Q 30/0233
USPC 705/14.33; 705/14.35

(57) ABSTRACT

A method and system is disclosed for providing dynamic group-based retail events in an m commerce platform. The method includes registering merchant-users and consumer-users, receiving a merchant profile, defining a group of consumer-users, wherein the group is time-limited and geographically limited, obtaining consent from a merchant-user to market and advertise an item to the group, determining a offer price for said item, generating an advertisement to present said offer price to each consumer-user of the group, transmitting said advertisement over a network for a predetermined period of time for each consumer-user of the group to review, receiving an acceptance of the offer price for the item, generating a redeemable voucher having a unique transaction identification and a scannable code and accepting the redeemable voucher.

### CROSS-REFERENCE TO RELATED APPLICATION

This application claims the benefit under 35 U.S.C. §119(e) of Provisional Patent Application No. 61/791,572, filed Mar. 15, 2013, the entire disclosure of which is hereby incorporated by reference.

### BACKGROUND

1. Technical Field

This disclosure relates generally to the field of mobile commerce systems and methods.

2. Description of the Related Art

The statements in this section merely provide background information related to the present disclosure and may not constitute prior art.

E-commerce, which generally refers to commercial activities online, is an area that is rapidly increasing in popularity as an increasing quantity of customers purchase items online rather than real-world “bricks and mortar” stores. E-commerce platforms are generally known as including the storefront visible by consumers and the means for conducting retailing transactions such as the buying and selling of goods and services (collectively referred to as “products”). There are several well-known e-commerce systems publically accessible via the world-wide-web sites that are devoted to commercial activities, and have fairly sophisticated websites that offer a wide variety of products for sale to consumers. Other websites provide more limited sets of specialty items and still others cater to primary business customers. Some web-based stores have physical world counterparts, but many do not.

Current e-commerce platforms enable merchants to focus product offerings on an individual-based level. That is, products are offered to the masses at a set price. It is known, however, to offer a discount for a particular product to an individual associated with a group, such as an auto insurance carrier. These discounts are known to be applied at checkout. However, this functionality does not permit dynamic construction of groups by merchants, does not permit group-based entry into the system, or permit merchant interactions defined by consumer-groups. Prior art e-commerce systems and methods are devoid of group-based retail events and time-limited group-based product offerings, nor do prior art e-commerce systems incorporate group-based functionality in a social networking environment.

Therefore, it would be advantageous to provide an e-commerce platform configured to enable merchants to provide group-based product offerings and retail events.

### SUMMARY

A method and system is disclosed for providing dynamic group-based retail events in an m commerce platform. The method includes registering merchant-users and consumer-users, receiving a merchant profile, defining a group of consumer-users, wherein the group is time-limited and/or geographically limited, obtaining consent from a merchant-user to market and advertise an item to the group, determining a offer price for said item, generating an advertisement to present said offer price to each consumer-user of the group, transmitting said advertisement over a network for a predetermined period of time for each consumer-user of the group to review, receiving an acceptance of the offer price for the item, generating a redeemable voucher having a unique transaction identification and a scannable code and accepting the redeemable voucher.

Certain embodiments of the present disclosure include a feature of creating a temporary group by assigning a user to be group administrator, generating and providing a unique group identification, generating a scannable code embodying the group identification, providing the scannable code to one or more individuals or to one or more consumer-users, receiving the unique group identification from the one or more individuals or the one or more consumer-users, verifying membership into the group and updating group membership of the group based upon the verifying.

This summary is provided merely to introduce certain concepts and not to identify key or essential features of the claimed subject matter.

### BRIEF DESCRIPTION OF THE DRAWINGS

One or more embodiments will now be described, by way of example, with reference to the accompanying drawings, in which:

FIG. 1 schematically shows an exemplary ecommerce system, in accordance with the present disclosure;

FIG. 2 schematically shows the exemplary computing device, in accordance with the present disclosure;

FIG. 3 schematically shows an exemplary embodiment of the mobile device, in accordance with the present disclosure;

FIG. 4 shows an exemplary user interface for a mobile device, in accordance with the present disclosure;

FIGS. 5A-5F show a user interface for performing various functions associated with a consumer-user's connections to merchant-users within the system, in accordance with the present disclosure;

FIGS. 6A-6F show a user interface for performing various functions associated with one or more offers to a consumer-user by one or more merchant-users within the system, in accordance with the present disclosure;

FIGS. 7A-7F show a user interface for performing various functions associated with one or more activities of a consumer-user from one or more merchant-users within the system, in accordance with the present disclosure;

FIGS. 8A-8E show a user interface for performing various functions associated with one or more earned or purchased offers of a consumer-user from one or more merchant-users within the system, in accordance with the present disclosure;

FIGS. 9A to 9C illustrate a voucher function enabling a user to purchase an offer and redeem from a merchant-user, and FIG. 9D illustrates exemplary steps of a voucher verification process through a flow diagram, in accordance with the present disclosure; and

FIG. 10 shows a control scheme 300 for providing dynamic group-based retail events in the ecommerce system, in accordance with the present disclosure.

### DETAILED DESCRIPTION

Various embodiments of the present disclosure will be described in detail with reference to the drawings, where like reference numerals represent like parts and assemblies throughout the several views. Reference to various embodiments does not limit the scope of the present disclosure, which is limited only by the scope of the claims attached hereto. Additionally, any examples set forth in this specification are not intended to be limiting and merely set forth some of the many possible embodiments for the present disclosure.

Various embodiments of the present disclosure will be described in detail with reference to the drawings, where like reference numerals represent like parts and assemblies throughout the several views. Reference to various embodiments does not limit the scope of the present disclosure, which is limited only by the scope of the claims attached hereto. Additionally, any examples set forth in this specification are not intended to be limiting and merely set forth some of the many possible embodiments for the present disclosure.

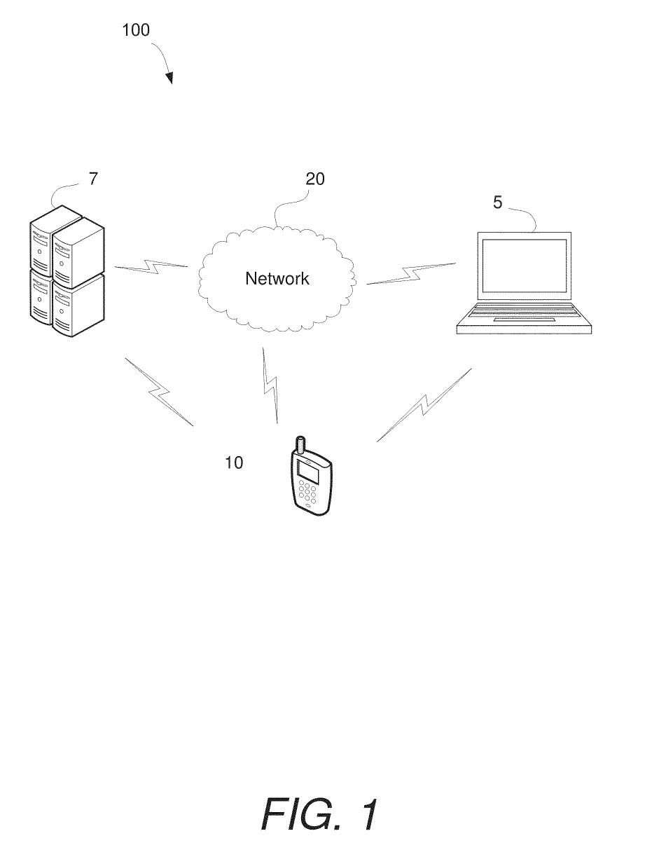

Referring now to the drawings, wherein the depictions are for the purpose of illustrating certain exemplary embodiments only and not for the purpose of limiting the same, FIG. 1 schematically shows an exemplary ecommerce system 100 that may help implement the methodologies of the present disclosure. The system 100 includes a computing device 5, a server system 7, a network 20, and a mobile device 10. As shown in FIG. 1, the computing device 5 may be directly communicatively connected to the mobile device 10 via the network 20 and/or directly communicatively connected to the mobile device 10. The server system 7 may be directly communicatively connected to the computing device 5 and the mobile device 10 via the network 20. The mobile device 10 may be physically connected to the network 20 or the computing device 5 during selected periods of operation without departing from the teachings herein. Components of the system 100 are shown in FIG. 1 as single elements. Such illustration is for ease of description and it should be recognized that the system 100 may include multiple additional mobile and computing devices.

The network 20 may be any suitable series of points or nodes interconnected by communication paths. The network 20 may be interconnected with other networks and contain sub networks network such as, for example, a publicly accessible distributed network like the Internet or other telecommunications networks (e.g., intranets, virtual nets, overlay networks and the like). The network 20 may facilitates the exchange of data between and among the mobile device 10, the computing device 5, and the server system 7 although in various embodiments the mobile device 10 may be directly connected to the computing device 5.

The computing device 5 and the server system 7 may each be: various embodiments of a computer including high-speed microcomputers, minicomputers, mainframes, and/or data storage devices. The server system 7 preferably executes database functions including storing and maintaining a database and processes requests from the mobile device 10 and the computing device 5 to extract data from, or update, a database as described herein below. The server 7 may additionally provide processing functions for the mobile device 10 and the computing device 5 as will become apparent to those skilled in the art upon a careful reading of the teachings herein.

In addition, the mobile device 10 may include one or more applications that the user may operate. Operation may include downloading, installing, turning on, unlocking, activating, or otherwise using the application. The application may comprise at least one of an algorithm, software, computer code, and/or the like, for example, mobile application software. In the alternative, the application may be a website accessible through the world wide web.

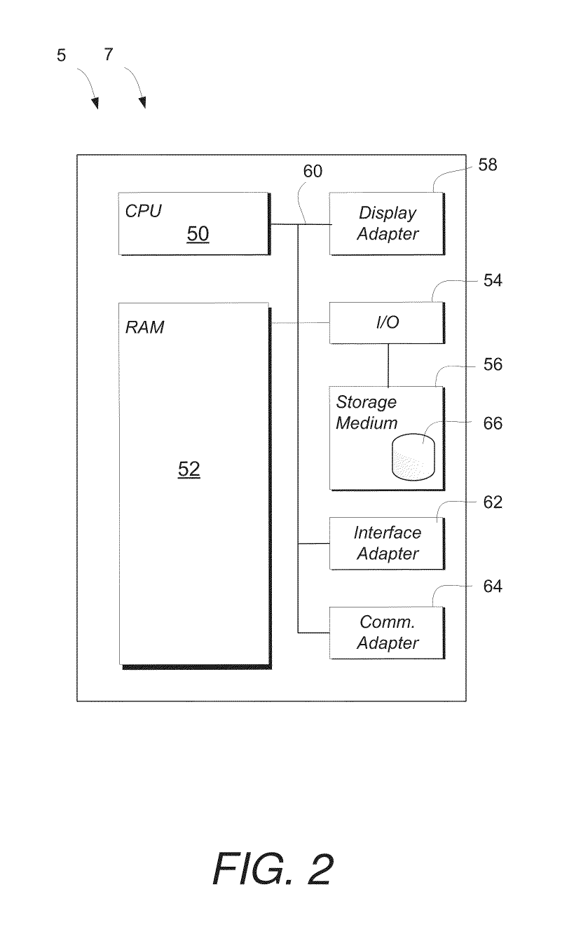

FIG. 2 shows the exemplary computing device 5. The computing device 5 includes a central processing unit (CPU) 50, random access memory (RAM) 52, input/output circuitry 54 for connecting peripheral devices such as a storage medium 56 to a system bus 60, a display adapter 58 for connecting the system bus 60 to a display device, a user interface adapter 62 for connecting user input devices such as a keyboard, a mouse, and/or a microphone, to the system bus 60, and a communication adapter 64 for connecting the computing device 5 to the network 20. In one embodiment, the communication adapter 64 is a wireless adapter configured for extraterrestrial communication such as in a communications satellite. The storage medium 56 is configured to store, access, and modify a database 66, and is preferably configured to store, access, and modify structured or unstructured databases for data including, for example, relational data, tabular data, audio/video data, and graphical data.

The central processing unit 50 is preferably one or more general-purpose microprocessor or central processing unit(s) and has a set of control algorithms, comprising resident program instructions and calibrations stored in the memory 52 and executed to provide the desired functions including parallel processing functions. As one skilled in the art will recognize, the central processing unit 50 may have any number of processing “cores” or electronic architecture configured to execute processes in parallel. In one embodiment, an application program interface (API) is preferably executed by the operating system for computer applications to make requests of the operating system or other computer applications. The description of the central processing unit 50 is meant to be illustrative, and not restrictive to the disclosure, and those skilled in the art will appreciate that the disclosure may also be implemented on platforms and operating systems other than those mentioned.

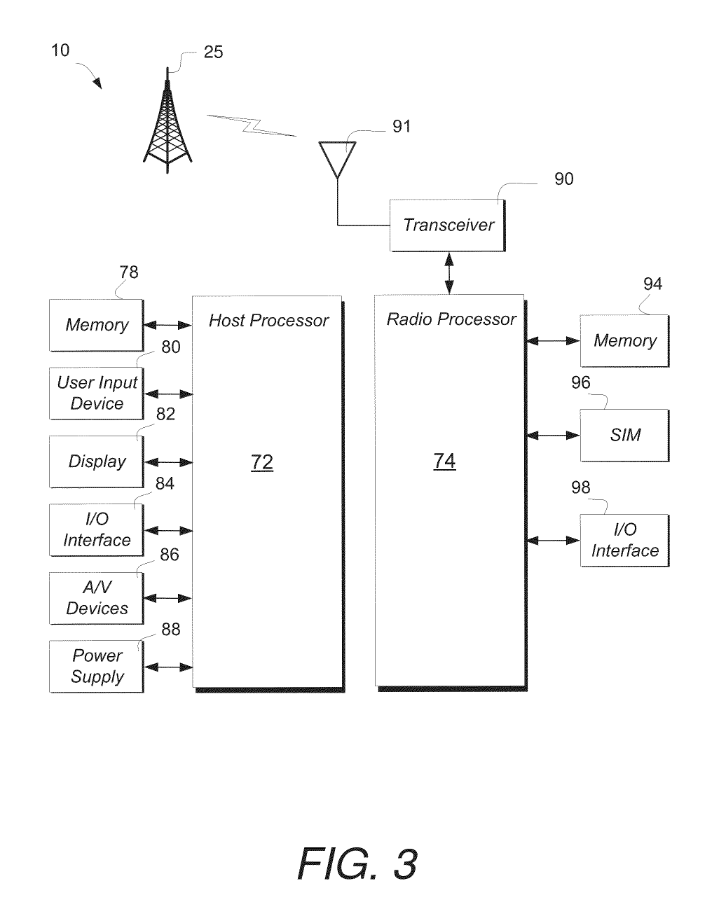

FIG. 3 schematically shows an exemplary embodiment of the device 10 configured to operate in a mobile environment. As shown in FIG. 3, the device 10 may include a dual processor architecture, including a host processor module 72 and a radio processor 74 (e.g., a base band processor or modem). The host processor module 72 and the radio processor 74 may be configured to communicate with each other using an interface 76. The device 10 may additionally include any digital and/or analog circuit elements, comprising discrete and/or solid state components, suitable for use with the embodiments disclosed herein. One skilled in the art will recognize upon a careful reading of the teachings herein that the radio processor may be omitted in a wired embodiment of the device 10.

The host processor module 72 may be configured to execute various computer programs (e.g., software, firmware, or other code) such as application programs and system programs to provide computing and processing operations for the device 10. The radio processor 74 may be responsible for performing data communications operations for device 10 such as transmitting and receiving data information over one or more wireless communications channels. Although the host processor module 72 and the radio processor 74 are shown and described as separate processors, such an illustration is for ease of description and it should be recognized that the functions performed by the host processor module 72 and the radio processor 74 may be combined on a single chip.

In various embodiments, host processor module 72 may be implemented as a host central processing unit (“CPU”) using any suitable processor or logic device, such as a general purpose processor, or other processing device in alternative embodiments configured to provide processing or computing resources to device 10. For example, host processor module 72 may be responsible for executing various computer programs such as application programs and system programs to provide computing and processing operations for device 10. The application software may provide a graphical user interface (“GUI”) to communicate information between device 10 and a user. The computer programs may be stored as firmware on a memory associated with processor 72, may be loaded by a manufacturer during a process of manufacturing device 10, and may be updated from time to time with new versions or software updates via wired or wireless communication.

System programs assist in the running of a computer system. System programs may be directly responsible for controlling, integrating, and managing the individual hardware components of the computer system. Examples of system programs may include, for example, an operating system, a kernel, device drivers, programming tools, utility programs, software libraries, an application programming interface (“API”), a GUI, and so forth.

The memory module 78 is preferably coupled to the host processor module 72. In various embodiments, the memory module 78 may be configured to store one or more computer programs to be executed by the host processor module 72. The memory module 78 may be implemented using any machine-readable or computer-readable media capable of storing data such as volatile memory or non-volatile memory, removable or non-removable memory, erasable or non-erasable memory, writeable or re-writeable memory, and so forth. Although the memory module 78 is shown as being separate from the host processor module 72 for purposes of illustration, in various embodiments some portion or the entire memory module 78 may be included on the same integrated circuit as the host processor module 72. Alternatively, some portion or the entire memory module 78 may be disposed on an integrated circuit or other medium (e.g., solid state drive) external to the integrated circuit of the host processor module 72.

A user input device 80 may be coupled to the host processor module 72. The user input device 80 may include, for example, an alphanumeric, numeric key layout and an integrated number dial pad. The device 10 also may include various keys, buttons, and switches such as, for example, input keys, preset and programmable hot keys, left and right action buttons, a navigation button such as a multidirectional navigation button, power/end buttons, preset and programmable shortcut buttons, a volume rocker switch, a ringer on/off switch having a vibrate mode, a keypad and so forth.

The host processor module 72 may be coupled to a display device 82. The display device 82 may include any suitable visual interface for displaying content to a user of the device 10, such as a liquid crystal display (“LCD”) such as a touch-sensitive color (e.g., 16-bit color) thin-film transistor (“TFT”) LCD screen. In some embodiments, the touch-sensitive LCD may be used with a stylus and/or a handwriting recognizer program.

An I/O interface 84 is preferably coupled to the host processor module 72. The I/O interface 84 may include one or more I/O devices such as a serial connection port, an infrared port, wireless capability, and/or integrated 802.11x (WiFi) wireless capability, to enable wired (e.g., USB cable) and/or wireless connection to a local or networked computer system, such as a workstation client, and/or the server system 7.

In one embodiment, the device 10 includes an audio/video (“A/V”) module 86 coupled to the host processor module 72 for communicatively connecting and communicating therebetween to various audio/video devices. The A/V module 86 may be configured to support A/V capability of the device 10 including components such as, a microphone, one or more speakers, an audio port to connect an audio headset, an audio coder/decoder (codec), an audio player, a video codec, a video player, and so forth. The A/V input module 86 may include an imaging module configured to capture digital images. The imagining module may include an optical sensor, e.g., a charged coupled device (CCD) or a complementary metal-oxide semiconductor (CMOS) optical sensor to facilitate camera functions, such as recording photographs and video clips. The image frames may be processed by the memory 78 or displayed on the display 82.

A power supply 88 configured to supply and manage power to components of device 10 is preferably coupled to the host processor module 72. In various exemplary embodiments, the power supply 88 may be implemented by a rechargeable battery, such as a removable and rechargeable lithium ion battery to provide direct current (“DC”) power, and/or an alternating current (“AC”) adapter to draw power from a standard AC main power supply.

As described herein above, the radio processor 74 may perform voice and/or data communication operations for the device 10. For example, the radio processor 74 may be configured to communicate voice information and/or data information over one or more assigned frequency bands of a wireless communication channel. The radio processor 74 may be implemented as a communications processor using any suitable processor or logic device, such as a modem processor or baseband processor. The radio processor 74 may include, or be implemented as, a digital signal processor (“DSP”), a media access control (“MAC”) processor, or any other type of communications processor in accordance with the described embodiments. Memory 94 may be coupled to the radio processor 74. Although memory 94 is shown as being separate from and external to the radio processor 74 for purposes of illustration, in various embodiments some portion may be included on the same integrated circuit as the radio processor 74. Further, the host processor module 72 and the radio processor 74 may share a single memory.

The device 10 may include one or more transceivers 90 coupled to the radio processor 74, each transceiver 90 may be configured to communicate using a different types of protocol, communication ranges, operating power requirements, RF sub-bands, information types (e.g., voice or data), use scenarios, applications, and so forth. For example, the transceiver 90 may include a Wi-Fi transceiver and a cellular or WAN transceiver configured to operate simultaneously. The transceiver 90 may be implemented using one or more chips as desired for a given implementation. Although transceiver 90 is shown as being separate from and external to the radio processor 74 for purposes of illustration, in various embodiments some portion may be included on the same integrated circuit as the radio processor 74. The transceiver is preferably connected to an antenna 91 for transmitting and/or receiving electrical signals. As shown in FIG. 3, the antenna 91 may be coupled to the radio processor 74 through transceiver 90.

A SIM device 96 may be coupled to radio processor 74. The SIM device 96 may be implemented as a removable or non-removable smart card configured to encrypt voice and data transmissions and to store user-specific data for allowing a voice or data communications network to identify and authenticate the user. The SIM device 96 also may store data such as personal settings specific to the user.

An I/O interface 98 may be coupled to the radio processor 74. The I/O interface 98 may include one or more I/O devices to enable wired (e.g., serial, cable, etc.) and/or wireless (e.g., WiFi, short range, etc.) communication between the device 10 and one or more external computer systems.

A radio-frequency identification (RFID) reader 40 may be coupled to the radio processor 74 or the host processor 72. In one embodiment, functions of the RFID reader 40 are incorporated into the radio processor 72 enabling the mobile device 10 to utilizes the transceiver 90 and antenna 91 to carry out functions of the RFID reader 40. The RFID reader 40 is configured to read identification information stored on an RFID tag by use of radio waves. In one embodiment, an RFID tag is formed of a microchip that is attached to an antenna and upon which is stored a unique digital identification number.

In operation, a user accesses the server system 7 via a client computer 8 operating a web browser 72 or other software application residing in memory 85 that permits it to display information downloaded from the server system 7. The server system 7 operates server software to perform functions described herein below, including an e-commerce system of the present disclosure executed using an operating system which interacts with the computing devices 5 and mobile devices 10 and one or more informational databases such as the database 66.

### Creation of Merchant Profile: Display of Merchants Online Profile on a Mobile Communication Device Form Factor.

In the mobile commerce system of the present disclosure, merchant user creates an online account and fills out online merchant profile. The online merchant profile comprises of merchant information such as name, geographic location, hours of operation, multimedia profile, offers, activities and the like. It is common knowledge that in mobile environment the mobile devices come in varying form factors having varying screen sizes, resolution etc. It is also common knowledge that there is often overlap between mobile commerce which is often executed by means of a mobile application and geared towards mobile devices; and e commerce that is geared more towards PC based users. It is contemplated that merchant user will fill out the merchant profile in an online environment using a set of online forms on a personal computer. It is also contemplated that merchant-user will need to view their merchant profile as it would appear in a mobile application. As such there is a need for an application that would convert a data set from online merchant profile into a corresponding data set in the mobile application and gives merchant a preview of what the data set would look like in the mobile application; preferably at the time when the online merchant profile is created by the merchant-user. As shown in figures, the present disclosure provides merchant-user the means to view their online merchant profile as it would appear in the mobile application. According to the preferred method, a data set in the online merchant profile corresponds to a screen on the mobile application. An executable computer program takes the online data set and configures the data set into predetermined corresponding data fields in the mobile application and gives a preview of the corresponding screen of the mobile application on a personal computer. In the preferred method, the preview of a entered data set is provided real time to the merchant user as the data is entered, so as to enable to merchant user to make any edits or changes at the time data is entered into the merchants online profile. This feature also enables the merchant user to vet the data entered into an online data field to determine if entered data is appropriate for corresponding mobile application data field. Alternatively, preview of the merchant profile on a mobile device can be provided on a demand basis. In the preferred method, the executable computer program is configured to take the online data set and configures the data set into predetermined corresponding data fields in the mobile application and gives a preview of the corresponding screen on the mobile application on one or more mobile devices (as chosen by the merchant user) with varying form factors, operating system, and other varying characteristics on a personal computer.

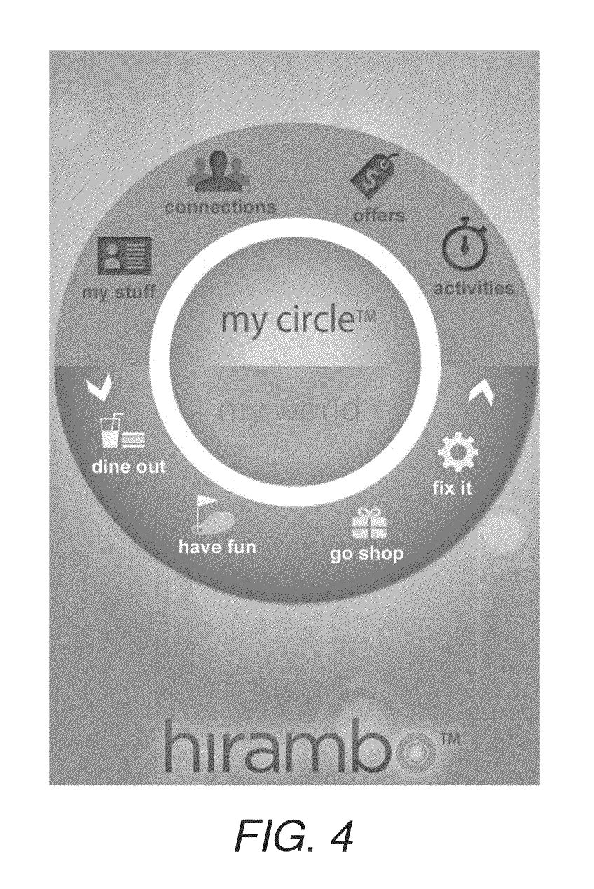

FIG. 4 shows an exemplary user interface 200 for a mobile device. The user interface 200 of the e-commerce system is configured to interface between a user and the database 66 via the network 20. As FIG. 4 shows, the interface 200 may include a plurality of navigational buttons configured to transition a user among a plurality of interface modules and graphical windows, each having one or more navigational buttons. The interface 200 graphically presents two sets of navigational buttons.

My Circle My World

A first set of navigational buttons is associated with functions available to all consumer-users of the mobile commerce system (‘my World™). A second set of navigational buttons is associated with functions personalized to a user (‘my Circle™). In one exemplary implementation, the user interface 200 is utilized as a home screen and may be adapted for use on the mobile device 10 for display of ‘My World’ and ‘My Circle’.

‘My World” section 200A comprises of merchant-user listings in the system. ‘My World’ section comprises of various navigational buttons, each depicting a category of service of product. Each navigational button provides user with a choice of merchants for corresponding service/product category. My world navigational buttons (by means of example) includes a navigational button 210 (“Dine out”) for browsing to an interface module having functions for searching and identifying for restaurants and dining merchants, a navigational button 212 (“Have fun”) for browsing to an interface module having functions for searching and identifying entertainment-based merchants, a navigational button 214 (“Go shop”) for browsing to an interface module having functions for searching and identifying various product merchants, and a navigational button 216 (“Fix it”) for browsing to an interface module having functions for searching and identifying merchants associated with various commercial services. These navigational buttons are only examples as additional my world navigational buttons can be incorporated. The list of merchant connections displayed in response to customer-user query in each service/product category is created using a “intuitive search engine” built into the system. The intuitive search engine is programmed to use profile information or survey answers provided by the customer-user. In one embodiment, the intuitive search engine may be configured to suggest relevant matches for each individual customer-user. According to one implementation, a matching function may be provided that is based upon common profile attributes, the customer-user's location or the location of the mobile device that the customer-user is using. The intuitive search engine is programmed with one or more user specific filters to determine the list of merchants to be displayed under each navigational button. One example of the filter includes, but not limited to, location specific results for merchant-users located within a predetermined radius from customer-user's location. Another example of a filter includes merchant users that meet customer-user generated preferences; such as sub categories in dine out 201 section i.e. (Italian eateries), customer-user generated weighted categories (Italian eateries more desired than German eateries etc.).

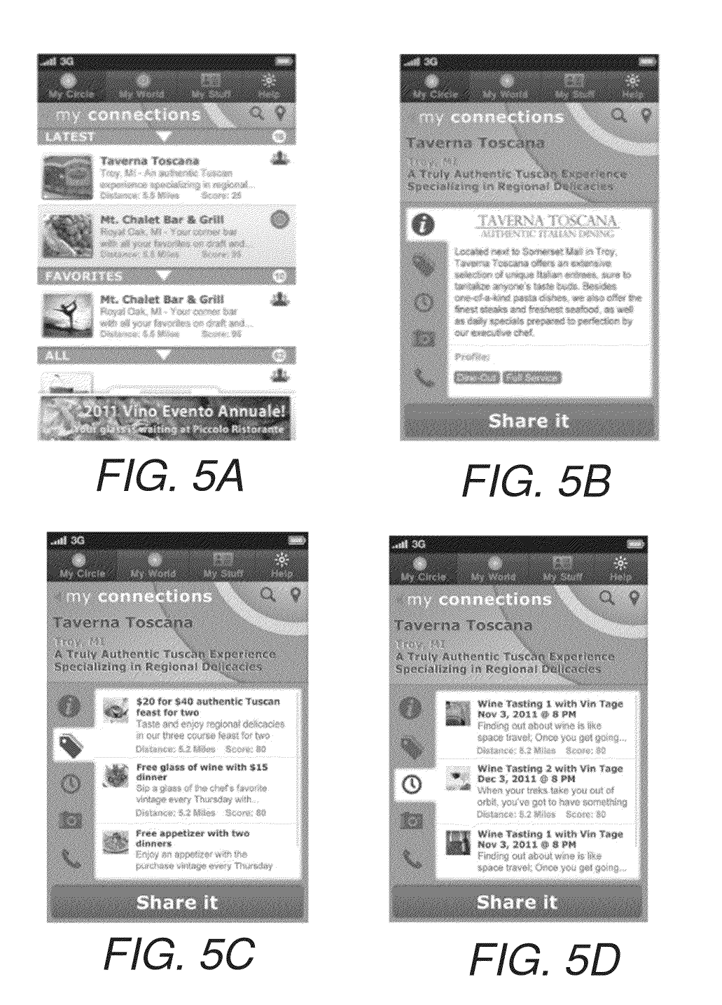

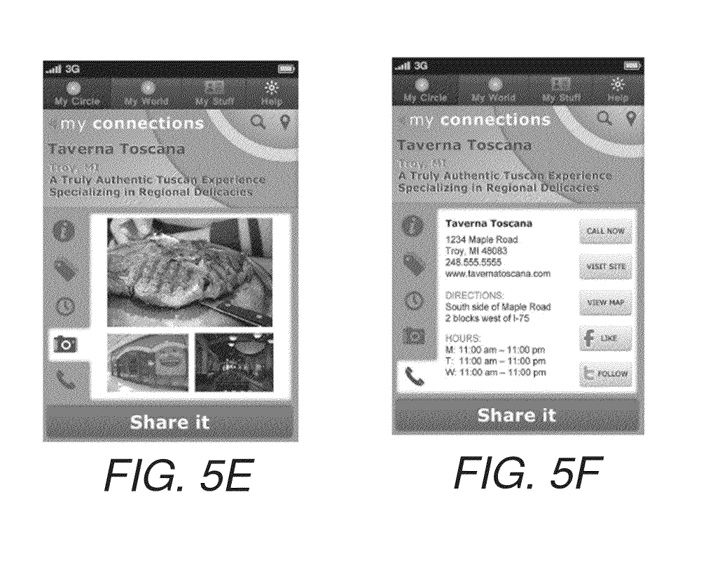

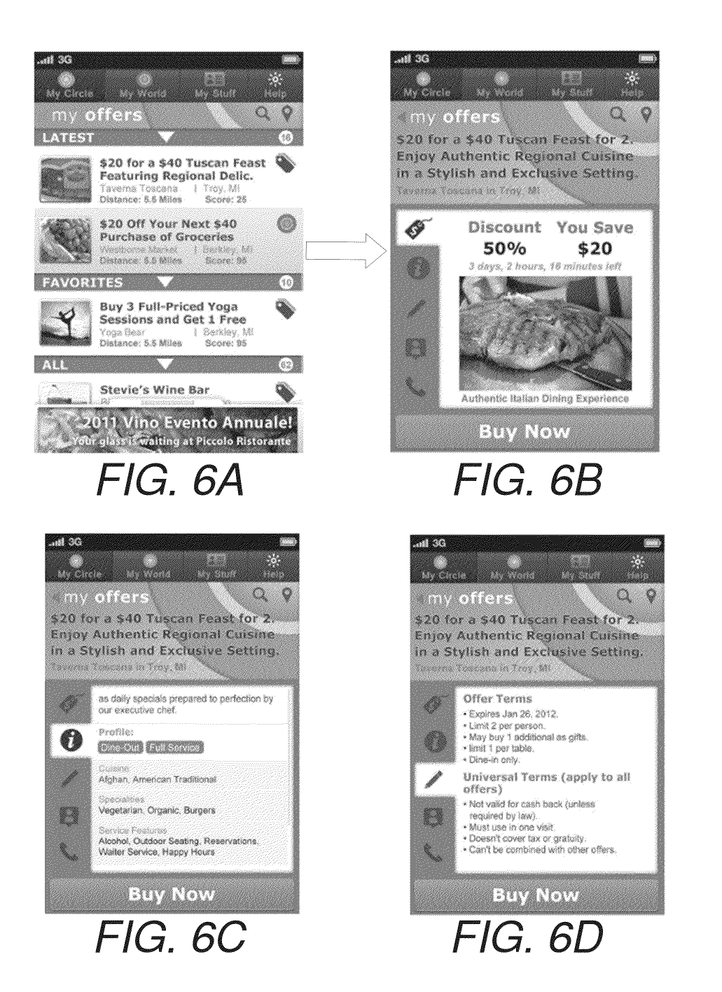

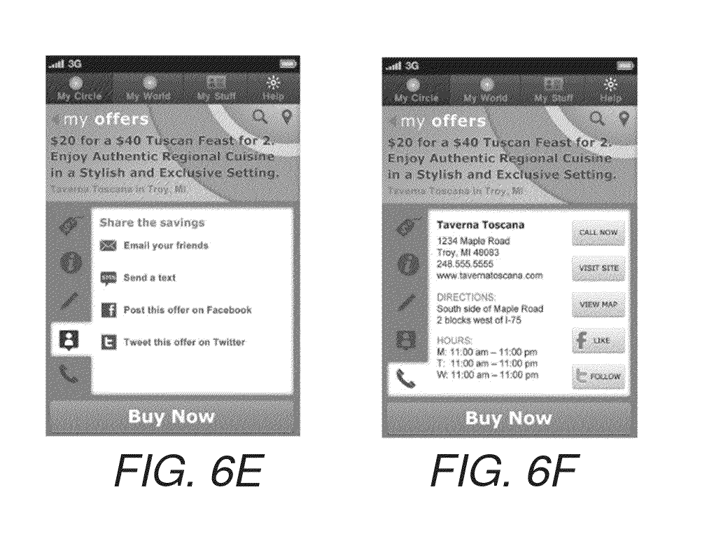

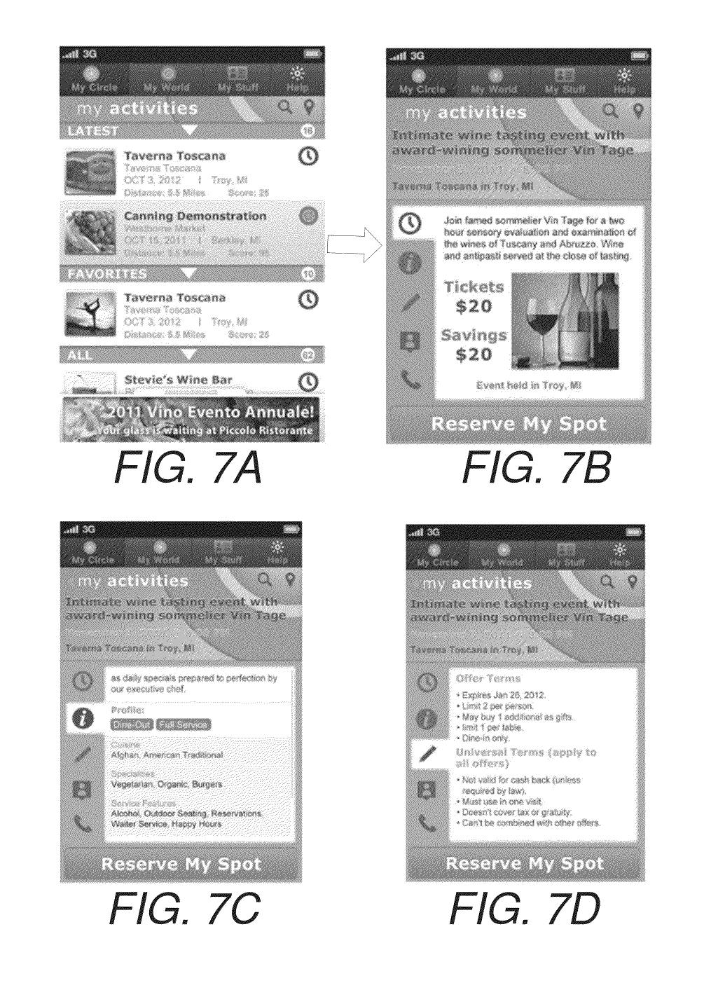

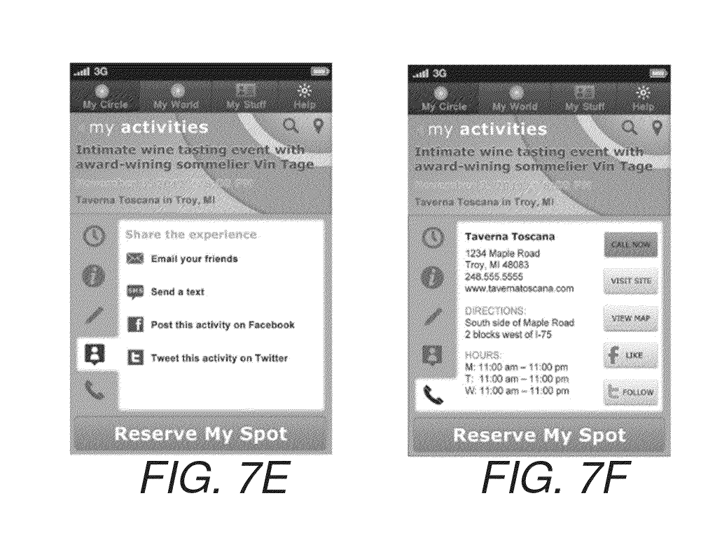

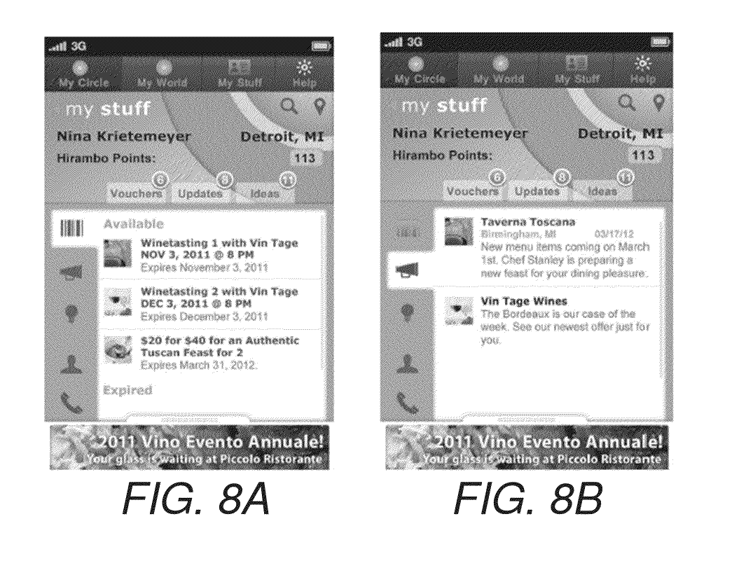

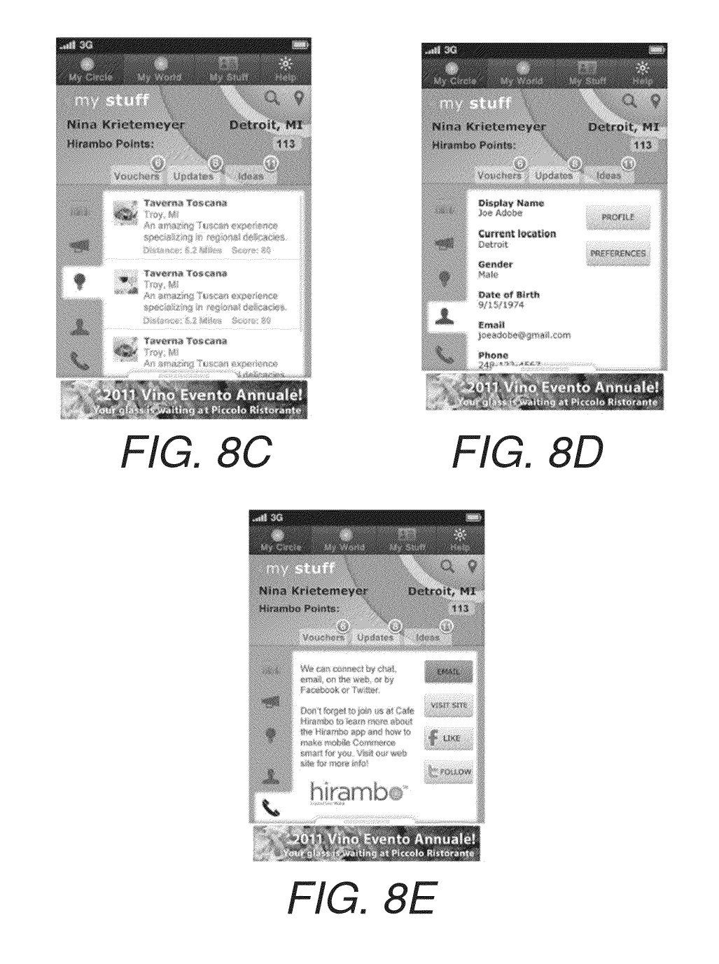

‘My Circle’ section 200B is specific to each customer-user and comprises of merchant-user listings that the customer-user has selected and added from the merchant-user listing under the ‘my world’ category. The second set of navigational buttons in ‘My Circle’ include 202 (“My Stuff”), 204 ‘My connections’, 206 ‘My offers’ and 208 ‘My activities’. ‘My Connections’ section includes all merchant-user listings that the consumer-user has selected from ‘My World’ section to be added to “My Circle’ section (FIGS. 5A-5F). ‘My Offers’ section includes all merchant-user offer listings that the consumer-user has selected from ‘My World’ section to be added to “My Circle’ section (FIGS. 6A-6F). ‘My Activities’ section includes all merchant-user activity listings that the consumer-user has selected from ‘My World’ section to be added to “My Circle’ section (FIGS. 7A-7F). ‘My Stuff’ section includes all merchant-user offers and activities that the customer-user has purchased/selected from ‘My World’ section to be added to “My Circle’ section (FIGS. 8A-8E).

FIGS. 5A-5F show a user interface for performing various functions associated with a consumer-user's connections to merchant-users within the system. FIGS. 5B-5F are selectively presented to a consumer-user upon selection of one or more tabs configured to operate as navigational buttons. FIG. 5A shows an exemplary list of connections including connections that are designated by a user as “favorites.” The user interface is preferably configured to allow a user to select other users or merchant-users they wish to add as connections. FIG. 5B shows information associated with an exemplary user connection. As FIG. 5B show, information may be accessible to the customer user about a merchant-user. FIG. 5C shows further information associated with a selected merchant-user connection. As FIG. 5C shows, the merchant-user may make product offers available for access my consumer-users. FIG. 5D shows information associated with merchant-user activities. Therein the consumer-user may select an activity with which to port or schedule in the calendaring functions of the system including a consumer-user's activities listing. FIG. 5E shows graphical information uploaded by a merchant-user such as photos. In various additional embodiments, videos and other graphical presentations may be included for access by a consumer-user. FIG. 5F shows contact information associated with the merchant-user and various association functions such as social networking integration and informational communications initiation functions. In various embodiments, contact information can include integrated call-out feature enabling a consumer-user to immediately place a telephone call to a phone number associated with the merchant-user, visit an external website, view a map having a location associated with a physical presence of the merchant-user, hours-of-operation, general directions, dynamic directions from a consumer-user's current location, and an physical address.

FIGS. 6A-6F show a user interface for performing various functions associated with one or more offers to a consumer-user by one or more merchant-users within the system. FIGS. 6B-6F are selectively presented to a consumer-user upon selection of one or more tabs configured to operate as navigational buttons. FIG. 6A shows an exemplary list of offers including offers that are designated by a user as “favorites” and may be further categorized based upon time receipt such as a “latest” category. The user interface is preferably configured to allow a user to select an offer and thereby transitioning to a navigational and informational view such as from an exemplary transition from FIG. 6A to FIG. 6B. As FIG. 6B shows, information associated with an offer may be displayed to a consumer-user including graphical-based information. FIG. 6C shows additional information about the offer and a profile related to the offer and merchant-user. FIG. 6D shows an exemplary display of terms and conditions that apply to the offer. FIG. 6E is an exemplary navigational tab configured to selectively display functions related to social networking and external communication integration and functions. For example, when utilized on a mobile device so equipped, a user is able to send the offer as an email, text, and/or post to a social networking site upon actuation of a corresponding button. FIG. 6F shows contact information associated with the merchant-user associated with the offer and various association functions such as social networking integration and informational communications initiation functions. In various embodiments, contact information can include integrated call-out feature enabling a consumer-user to immediately place a telephone call to a phone number associated with the merchant-user, visit an external website, view a map having a location associated with a physical presence of the merchant-user, hours-of-operation, general directions, dynamic directions from a consumer-user's current location, and an physical address.

FIGS. 7A-7F show a user interface for performing various functions associated with one or more activities of a consumer-user from one or more merchant-users within the system. FIGS. 7B-7F are selectively presented to a consumer-user upon selection of one or more tabs configured to operate as navigational buttons. FIG. 7A shows an exemplary list of activities including activities. The activities may be selectively categorized by the consumer-user from display therein including functionality for selective designation of an activity as a “favorites” and may be further categorized based upon time receipt such as a “latest” category. The user interface is preferably configured to allow a user to select an activity and thereby transitioning to a navigational and informational view such as from an exemplary transition from FIG. 7A to FIG. 7B. As FIG. 7B shows, information associated with the activity may be displayed to a consumer-user including graphical-based information. FIG. 7C shows additional information about the activity and a profile related to the activity and associated merchant-user. FIG. 7D shows an exemplary display of terms and conditions that apply to the activity. FIG. 7E is an exemplary navigational tab configured to selectively display functions related to social networking and external communication integration and functions. For example, when utilized on a mobile device so equipped, a user is able to send the offer as an email, text, and/or post to a social networking site upon actuation of a corresponding button. FIG. 7F shows contact information associated with the merchant-user associated with the offer and various association functions such as social networking integration and informational communications initiation functions. In various embodiments, contact information can include integrated call-out feature enabling a consumer-user to immediately place a telephone call to a phone number associated with the merchant-user, visit an external website, view a map having a location associated with a physical presence of the merchant-user, hours-of-operation, general directions, dynamic directions from a consumer-user's current location, and an physical address. In one embodiment, activities may be included in an integrated calendar management functions. In another implementation, consumer-users may be provided a personal calendar with which they could schedule or track the activities. Merchant-users may be provided an ability to send offers and activities to their connections.

FIGS. 8A-8E show a user interface for performing various functions associated with one or more earned or purchased offers by a consumer-user from one or more merchant-users within the system. FIGS. 8A-8E are selectively presented to a consumer-user upon selection of one or more tabs configured to operate as navigational buttons; as in ‘my stuff’ 202 navigational button. The m commerce system may include functionality for use or loyalty points (Hirambo points) shown in FIGS. 8A-8E, wherein points are awarded based upon use of the system and intended to incentivize continued use. The points may then be redeemed for products from merchant-users. In one embodiment, points may be earned by purchase of offers or may be earned by referral of offers to other users. FIG. 8A shows an exemplary list of offers and activities purchased, awarded or unredeemed offers. The list may be categorized in one or more categories including currently available offers or activities and expired offers and activities. FIG. 8B shows an exemplary navigational tab configured to selectively display a list of updates from merchant-users that have been added to a customer-user's ‘my circle’ section. FIG. 8C shows an exemplary navigational tab configured to selectively display a list of system-generated suggestions (merchant-user, offers, activities etc.) to a consumer-user. The suggestions may be provided based upon prior customer-user activity, survey answers, connections, customer-user's profile, intuitive search engine etc. FIG. 8D shows an exemplary navigational tab for displaying information associated with a consumer-user's profile. As described herein above, the system is configured to permit users to enter user information to create a personal data record, i.e., a consumer-user profile. Users can enter information in the user interface on one of multiple communication devices such as personal computer, smart phones etc. in various data fields. Exemplary data fields can include a user id, user name, current location, gender, birth date, email address, and phone number.

Short Term Enterprises

In one embodiment, the data fields, the user can specify groups or activities with which the customer-user is associated, such as Memorial Day 5 k Runner group; Randolph county chamber of commerce etc.; and the beginning and ending dates of the association. In one embodiment, data fields specific to a selected group or activity are generated in response to customer-user selected group or activity. A beginning date and ending date may be established corresponding to a date range during which time the user was associated with the group or activity. The m commerce system is programmed to present offers and activities to consumer-user that are specific to groups and activities selected by the consumer-user. Such offers and activities are presented to the consumer-user for a specified time period that corresponds to the to duration of the selected group or activity. As a way of illustration; a consumer-user (attendee) who is attending American College of Gastroenterology meeting (herein after referred to as ‘the meeting’) in Chicago from Oct. 1-5, 2009 adds the meeting to consumer user's profile. Merchant-users are provided means to enter offers and activities that are specifically directed towards to the attendees of the meeting for the duration of the meeting. The m commerce system of the present disclosure is programmed to present offers and activities from merchant-users with that are specific to the meeting to the attendees of the meeting for the duration of the meeting on their mobile communication device.

Additional functionality associated with a profile may be supplied by the system. In one embodiment, the consumer-user's profiles is established to enable a consumer-user to generate a personalized page with which they can provide profile information, their photo, a personal description, their interests, among other information about the user. A merchant-user's profile may be established to enable merchant-users to generate a public page with which they can provide business related information such as hours of operation, location, product offerings, and personnel information. Each profile may also be configured to accept uploaded images, documents, videos, or any other type of information. Such information may be selectively shared with the community, such as on a user-by-user basis, group basis, or by any other type of parameters. In a preferred embodiment, a merchant user is provided with controls and tools to create a merchant profile with unique, personalized and exclusive features that distinguishes merchant's profile from other merchant profiles in the system. To this end, controls may be provided to the merchant-user to modify and create unique, personalized and exclusive features. FIG. 8E shows an exemplary navigational tab for displaying information associated with the m commerce system's contact information. Social networking integration and informational communications initiation functions may be included. In various embodiments, contact information can include integrated communications features enabling a consumer-user to immediately send an email communication, visit an external website, and share or send communications to a particular external social networking system.

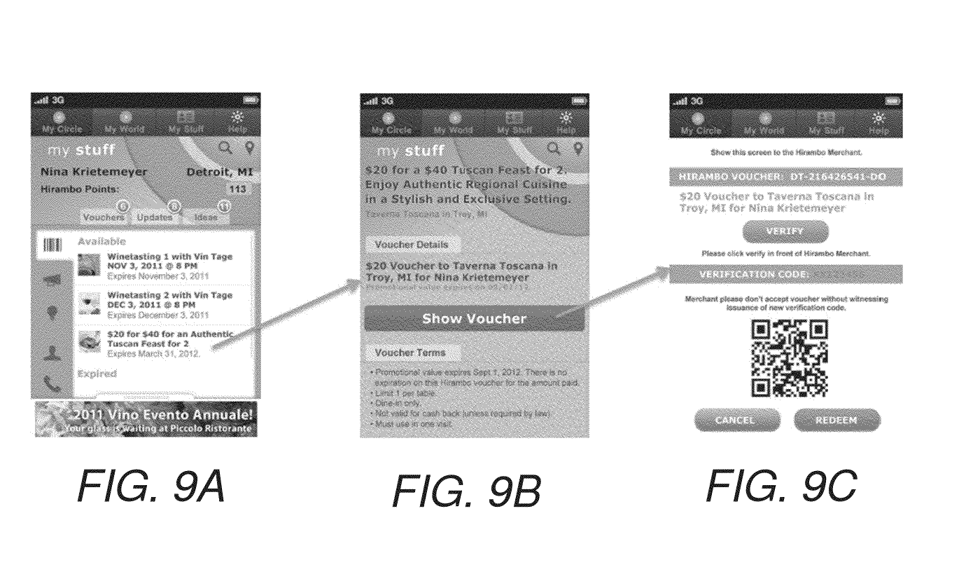

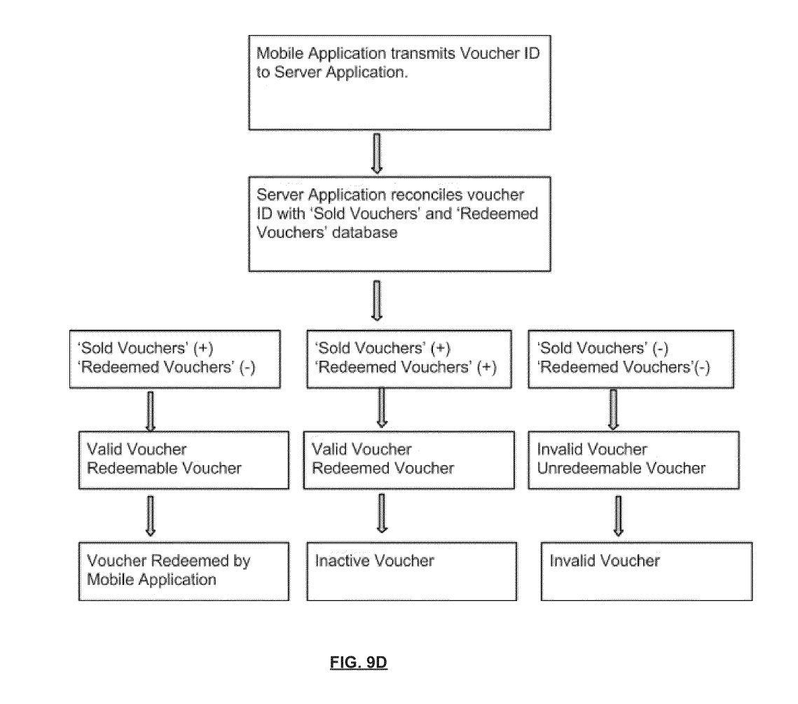

FIGS. 9A to 9C illustrate a voucher function enabling a user to purchase an offer/activity and redeem from a merchant-user. FIG. 9A shows an exemplary list of offers and activities associated with a consumer-user as described with reference to FIG. 9A. Upon selection of an offer or activity, a user is navigated to an interface such as exemplary FIG. 9B having information, functional, and navigational capabilities associated with a selected offer or activity. As FIG. 9B shows, description, terms of redemption, and details associated with the selection may be presented to the user. A navigation button is also presented enabling a user to present a voucher for redemption to the merchant-user. The voucher may include a scannable code such as a bar code or QR code, a unique verification code, a system code, or any other identification information.

FIG. 9C-9D shows a voucher verification process. The server application contains executable programming code that generates a unique voucher ID whenever a voucher is purchased and stores it is ‘sold vouchers’ database. The server application also contains executable programming code that captures and stores voucher ID's of all redeemed vouchers in a ‘redeemed voucher’ database. When a consumer-user wishes to redeem a voucher; consumer-user activates the “verify” button as shown in FIG. 9C. Thereafter, the mobile application sends a verification request to the server application. The verification request contains the corresponding voucher ID. Upon receiving the verification request, the server application executes programming code to reconcile the transmitted voucher ID with the ‘sold vouchers’ database; and the ‘redeemed vouchers’ database. If the server application reconciles the voucher code contained in the verification request in the ‘sold vouchers’ database and not the ‘redeemed vouchers’ database; then the voucher is deemed authentic and a unique verification code is transmitted to and displayed on the mobile communication device. Thereafter, upon acceptance of the voucher by the merchant-user, the voucher is redeemed; and the corresponding voucher ID is transmitted back to the server application; where it is saved into ‘redeemed voucher’ database. If the voucher code transmitted with the verification request if not reconciled with the ‘sole vouchers’ database; then the application server determines the voucher to be invalid; and transmits an ‘invalid voucher’ message to the mobile application. If the server application reconciles the voucher code transmitted with the verification request with the ‘sold vouchers’ database; but not with the ‘redeemed vouchers’ database, then the application server determines the voucher to be already redeemed; and transmits an ‘already redeemed voucher’ message to the mobile application.

In operation, the merchant-user may be located by other consumer-users and merchant-users based on the information provided in their profile. Various additional functions, as described herein below, may be executed based upon information in a particular merchant-user's profile. In some cases this information may be accessed by consumer-users such as contacts of the merchant-user. The merchant-user profile may include status information relating to the merchant, such as, for example, current location, ranking, types of business associations, etc. Such information may be generated and provided, for example, by the server 7 as discussed above. Such server-based content may be generated as needed and displayed in the merchant-user profile, or in other types of interfaces generated by the system (e.g. a top user's screen, a location map, etc.).

In various embodiments, the m commerce system can include: a blackboard feature wherein merchant-users and consumer-users are permitted to create, collaborate, and share knowledge simply by creating a set of user-modifiable to which each user may contribute. For instance, a merchant-user may be permitted to create their own weblog where other permitted members (e.g. a group of consumer-user) may share information with the merchant-user and the group as a whole. Users may be permitted to share information in the field. Some information posted in the online community may be generated by a mobile-application such as location and time-based info. In one embodiment, the blackboard feature may be adapted for particular merchants having highly specialized product offerings.

Exemplary functions of an m commerce system can further include: integrated opinion polls. It may be also beneficial to determine what the consumer-users think about certain products, or to otherwise determine what they are thinking. Merchant-users could solicit and understand the opinions and ideas of their connections or other consumer-users by creating and delivering opinion polls. These opinion polls may be displayed, for example, to the consumer-user and information may be received and summarized to other users in near-real time. Multiple polls could be activated at any time by administrators or merchant-users, depending on what information is desired. Polls may also be targeted to particular consumer-users based on their background or any other information known about the user. In one embodiment, information and responses from a consumer-user may be associated with a particular user's profile.

Exemplary functions of an m commerce system can further include: private messaging. Consumer-users may be permitted to communicate privately and directly with other consumer-user and merchant-users. For example, every user may be provided a private in-box where they may store private discussions with other users.

Exemplary functions of an m commerce system can further include: multimedia file sharing. Merchant-users may be provided the ability to post content in one of a number of format types (e.g., video, music, documents, etc.) to their profile or post files to any group of which they are a part. Once posted, files could be rated and commented upon by the community. There also may be provided the ability to create and share new files (e.g. pictures, video, audio) at tagged locations and post or send these files to other users.

Exemplary functions of an m commerce system can further include: customized notifications. Members could choose to be notified by email when predetermined activities, offers, or events occur. Members could also receive email or subscribe to feeds (e.g. RSS feeds) for any group discussion or any predetermined event, such as a sponsorship of a within a project or tagging of a within a selected geographical region.

Referring back to FIG. 4, various functions of the m commerce system are conveniently present to a user to promote ease of access and quick identification of products sought by a consumer-user. The user interface 200 includes integrated keyword search functionality. The searching features are assisted by categories of offers, merchant-users, and activities. For example, offers, activities, and merchant-users associated with the food and restaurant industry may be associated with the “dine-out” category, whereby searches into the system subsequent to selection of the “dine-out” navigational button are restricted to offers, activities, and merchant-users associated with the “dine-out” category. Similarly, searches made after selecting the “have-fun,” “go-shop,” and “fix-it” category are restricted to offers, activities, and merchant-users associated with the respective categories.

In one embodiment, further search features may be included within the system and made available to a consumer-user. For example, the system could support keyword searching across content (files names and descriptions), merchant-users and consumer-users in the system. In one embodiment, through one common search, members could find some or all of the following—relevant people, groups, forum posts, documents, media files, offering, and activities. The system may be capable of supporting tagging of content by others, performing advanced context-based searching, meaning abstraction, or other search-related functions that facilitate searching for merchant-users and their related content. In another embodiment, searches may be restricted based upon a tag.

Exemplary functions of an m commerce system can include: discussion forums and rating system. In one example implementation, the system may include a complete discussion forum system which allows users to post, reply, search, and rate messages. In addition, discussions could be subscribed to (e.g. via email, RSS, etc.). Users may also be provided a rating and comment system that enables members to provide feedback on discussion posts and files. Such feedback may also assist users in determining or searching for relevant content.

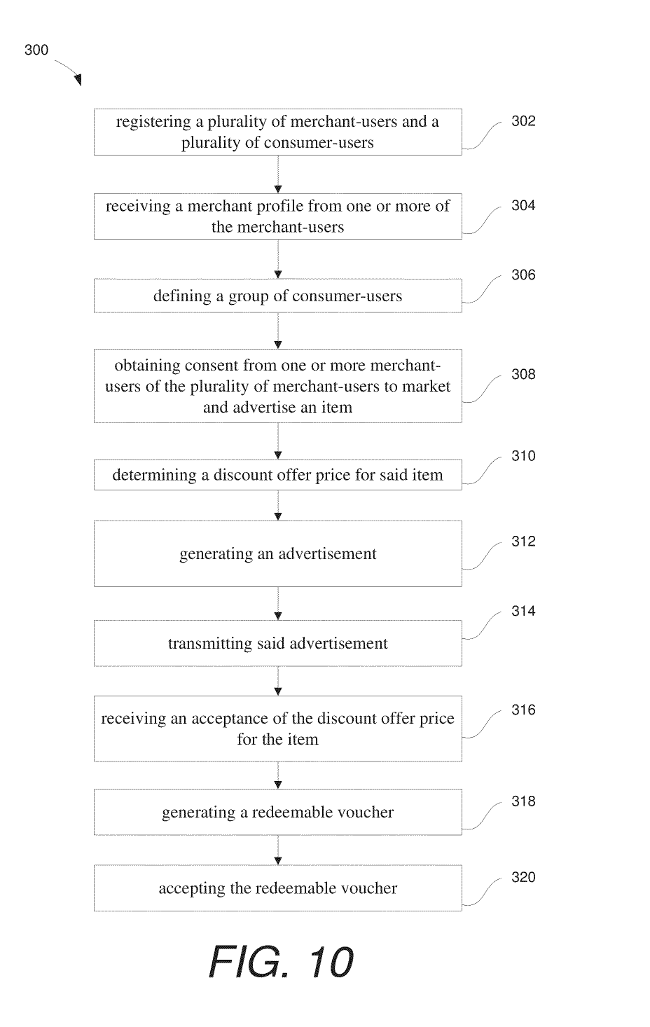

FIG. 10 shows a control scheme 300 for providing dynamic group-based retail events in the ecommerce system. One skilled in the art will recognize that multiple steps of the control scheme 300 may be performed in parallel and concurrently including process requests from multiple devices, for example. The control scheme is configured, in one exemplary implementation, to provide computing services to devices such as the mobile device 10 or a desktop configuration such as the computing device 5. Dynamic group-based retail events are useful when consumer-users are temporarily grouped together, such as for an event, conference, or meeting. The methods and teachings of the control scheme 300 are particularly useful in context of an out-of-town conference when attendees are unfamiliar with the local offerings. By utilizing the control scheme 300 much of the economic transaction costs of identifying, locating, selecting are reduced, saving attendees time and more effectively managing resources. In one embodiment, discounts may be made available to the group as described herein below.

The control scheme is initiated at step 302 by registering a plurality of merchant-users and a plurality of consumer-users with the ecommerce platform over a network. The registration process may include generating a profile and answering one or more questions. In one embodiment, the consumer-users are directed to a survey configured to determine correlations for product advertisement and marketing. Step 304 includes receiving a merchant profile from one or more of the merchant-users. The merchant profile may include one or more products offerings, activities, contract information, and information to integrate one or more external social networking systems.

For group-based operation, such as during a conference as described herein above, a system user, administrator, or consumer-user defines a group of consumer-users at step 306. The group may be formed by sending invitations from the system inviting the individual to download software and initiate the registration process. In one embodiment, the group may include individuals already registered as consumer-users. The group is temporarily formed and can exist only for a predetermined or selected geographic region. In this way, individuals who are temporarily joined or grouped in some endeavor can be served or guided in an unfamiliar environment or guided to services effectively without having to expend economic transaction costs as described herein above. In one embodiment, the group is defined by providing a unique scannable code to consumer-users. Upon receipt of the unique code embodied in the scannable code, such as a bar code or QR code, the control scheme 300 may include the sender in the group. In this way, at a conference, a group administrator may make the code available at a meeting, for example, wherein each attendee may scan the code using their mobile device, and thereby become a group member.

The process continues at step 308 wherein one or more merchant-users are invited to provide products to the defined group. The invitation may include an offer to subsidize the product to the group. The merchant-user is invited to provide consent to market and advertise one or more products to members of the group. At step 310, the price for a product is determined. The price may be determined based upon an accepted subsidy, i.e., a prepayment by a group administrator, or set by the merchant-user in response to the number of group members. In one embodiment, the product is offered at a discount offer price, said discount offer price being a reduction in amount from the standard offer price of that product.

At step 312 an advertisement is generated for the product. The advertisement may include the discounted price. The advertisement may be a simple listing of the products or merchant-users available for lunch, for example. At step 314 the advertisement is displayed or transmitted to each group member for review. The advertisement may be electronically transmitted to a group member's mobile device or physically distributed such as at the physical assembly of the group members during the conference, for example. The transmission or communication of the advertisement may be made in any number of ways including via email, private message through the ecommerce communication, website URL, or offer to download over a network. As the group is temporarily assembled, product offers and advertisements may be time-limited as well. However, in situations where the product offering is at a normal, standard price merchant-users may make product offering and activities having a longer duration.

At step 316, a consumer-user, being a group member, may accept the product offering using their mobile device or computing device in communication over the network. As described hereinabove the product offering may be at a discounted offer price from a standard price. Upon acceptance of the product offering, at step 318, a redeemable voucher is generated. The redeemable voucher includes a unique transaction identification and preferably a scannable code such as a bar code or QR code. The redeemable voucher may be transmitted to the merchant-user via the network, or physically presented to the merchant-user at step 320 for acceptance. Physical presentation of the redeemable voucher may include the merchant-user scanning the scannable code for verification and acceptance.

In one embodiment, group administrators may be created by a merchant-user, a consumer-user or a system administrator. Administrators or merchant-users may be provided the capability to set up group functions around which people can post and/or share files, engage in discussions and set up group meetings. Such groups may be interactively defined and set up by users from users that exist in the system. Users may define and save their own groups, and may contact users of such groups to arrange a group meeting. Such group meetings may support a variety of media types such as audio, video, images, documents, or similar items.

Exemplary functions of an ecommerce system can further include: user roles management. Administrators of the ecommerce system may be provided tools that customize each role they wish to display within the system. For instance, there may be roles for different types and security-level accounts for a particular merchant-user.

Exemplary functions of an ecommerce system can further include: targeted sponsorship/advertising engine. Administrators may be provided tools to create ad units that are featured throughout the ecommerce platform. These ad units may be configured to include any message (combination of image, text and link) Further, these ad units may be used to feature anything from advertiser content, sponsor messaging, cross-selling messages, or featured groups within the community. Advertising units may also be broadcast throughout the site for all consumer-users to see, they may be displayed to only subsets of the consumer-users based upon criteria within a consumer-users' profile, or they may be displayed based upon group membership. They also may be displayed in response to user's actions or location. Further, the ecommerce system may be coupled to an ad network where advertisers pay to reach particular users (e.g., by rating, demographic, or other information).

The disclosure has described certain preferred embodiments and modifications thereto. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

What is claimed is:

1. Method for providing dynamic group-based retail events in an ecommerce platform, the method comprising:
registering a plurality of merchant-users and a plurality of consumer-users with the ecommerce platform over a network via a network server;
receiving a merchant profile from one or more of the merchant-users;
defining a group of consumer-users, wherein the group is a sub-set of the plurality of the consumer-users, and wherein the group is time-limited and geographically limited;
obtaining consent from one or more merchant-users of the plurality of merchant-users to market and advertise an item to the group normally provided by said merchant at a standard offer price;
determining a discount offer price for said item, said discount offer price being a reduction in amount from the standard offer price of that item;
generating an advertisement to present said discount offer price to each consumer-user of the group;
transmitting said advertisement over the network through said network server for a predetermined period of time for each consumer-user of the group to review;
receiving an acceptance of the discount offer price for the item over the network;
generating a redeemable voucher, wherein the redeemable voucher comprises a unique transaction identification and a scannable code; and
accepting the redeemable voucher.

2. The method of claim 1, further comprising:
providing reward points to consumer-users based upon use of the ecommerce platform; and
allowing each consumer-user to redeem said reward points.

3. The method of claim 1, wherein defining a group comprises:
assigning a user to be group administrator;
generating and providing a unique group identification;
generating a scannable code embodying the group identification;
providing the scannable code to one or more individuals or to one or more consumer-users;
receiving the unique group identification from the one or more individuals or the one or more consumer-users;
verifying membership into the group; and
updating group membership of the group based upon the verifying.

4. The method of claim 3, wherein the scannable code is a QR code.

5. The method of claim 3, wherein the verifying further includes a request to manually provide a group password via keyboard typing into a data field.

6. The method of claim 5, further comprising:
associating the group with a password;
receiving a character string from the one or more individuals or the one or more consumer-users;
authenticating the one or more individuals or the one or more consumer-users by confirming the received character string is the password; and
updating the group membership based upon the confirming.

7. The method of claim 5, wherein the providing the scannable code further comprises: displaying the scannable code and the password.

8. The method of claim 7, wherein the scannable code is a QR code and wherein the displaying further comprises embodying the scannable code and the password on a tangible medium.
